(19) United States
(12) Patent Application Publication
(10) Pub. No.: US 2004/0090070 A1
(43) Pub. Date: May 13, 2004

(54) Manually-operated device for supplying electrical power to mobile telephones, flashlights, toys, or other battery-operated electrical devices

(75) Inventor: Kenneth D. Eisenbraun, Bloomfield Village, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(73) Assignee: United Global Sourcing Incorporated, Troy, MI (US)

(21) Appl. No.: 10/293,838

(22) Filed: Nov. 13, 2002

(51) Int. Cl. H02P 9/04

(52) U.S. Cl. 290/1 R

(57) ABSTRACT

A manually-operated device for supplying electrical power to an external electrical device such as a mobile telephone, flashlight, etc. The device includes an electrical generator enclosed within a housing dimensioned for hand-carrying by a user and having a drive member for manually driving the electrical generator to generate an electrical voltage, and a reel having a retractable extension cord wound thereon. One end of the retractable extension cord is connected to the output of the electrical generator, and the opposite end carries an electrical connector for connection to an external electrical device for supplying power thereto when the electrical generator is manually driven by the drive member. The housing further carries a light source selectively energizable by an electrical switch to enable the device also to serve as a flashlight, and a ring which is openable and closable to facilitate carrying the device and its use as a key ring.

### FIELD OF THE INVENTION

The present invention relates to manually-operated devices for supplying electrical power to mobile telephones, flashlights, toys, or other battery-operated electrical devices.

### BACKGROUND OF THE INVENTION

Battery-operated electrical devices are increasingly being used in a wide variety of fields. Since a battery supplies a finite amount of electrical power, the battery must be periodically recharged and/or replaced. However, recharging a battery or replacing it is not always possible or convenient at the particular times the battery becomes discharged.

Many manually-operated electrical recharging devices have been proposed and are described in the patent literature, for example in U.S. Pat. No. 3,573,479 of Apr. 6, 1971; U.S. Pat. No. 5,949,215 of Sep. 7, 1999; U.S. Pat. No. 6,316,906 of Nov. 13, 2001; European Patent Application EP 0 786 849 published Jul. 30, 1997; and U.K. Patent Application GB 2 347 800 published Sep. 13, 2000. Such devices, however, are generally of limited application and have not yet found widespread use for one reason or another.

### OBJECTS AND BRIEF SUMMARY OF THE PRESENT INVENTION

An object of the present invention is to provide a novel manually-operated device for supplying electrical power to mobile telephones, flashlights, toys, or other battery-operated electrical devices, providing a number of important advantages over the prior known devices as will be described more particularly below.

According to one aspect of the present invention, there is provided a manually-operated device for supplying electrical power to an external electrical device, comprising an electrical generator enclosed within a housing dimensioned for hand-carrying by a user and including a drive member for manually driving the electrical generator to generate an electrical voltage at an output thereof; and a reeling device carried by the housing and having a retractable extension cord wound thereon, one end of the retractable extension cord being connected to the output of the electrical generator, the opposite end of the retractable extension cord carrying an electrical connector for connection to an external electrical device for supplying power thereto when the electrical generator is manually driven by the drive member.

As will be described more particularly below, such a device provides a number of important advantages. Thus, the inclusion of the reeling device with the retractable extension cord enables the device to be more conveniently used with the battery-operated electrical device to which it is to be connected. For example, if the battery-operated device is a mobile telephone, the manually-operated generator device may be held in one hand of the user and manually operated, while the mobile telephone is held in the other hand of the user and either used in its normal manner for making or receiving telephone calls, or for having its battery recharged. The same advantage would be present where the battery-operated device is a portable flashlight, which could be held in one hand of the user, while the manually-operated generator device is held and operated by the other hand of the user for powering the flashlight or for recharging its battery. If the battery-operated device is a mobile toy, the retractable extension cord would permit the toy to move while the user manually operates the device for supplying the electrical power to the toy for powering it or for recharging its battery.

According to another aspect of the present invention, there is provided a manually-operated device for supplying electrical power to an external electrical device, comprising an electrical generator enclosed within a housing dimensioned for hand-carrying by a user and including a drive member for manually driving the electrical generator to generate an electrical voltage at an output thereof; an electrical connector connected to the output of the electrical generator for connection to an external electrical device; a light source carried by the housing; and an electrical switch for selectively switching the output of the electrical generator to the electrical connector for supplying power to the external electrical device when connected thereto, or to the light source for supplying power thereto to enable the device also to be used as a flashlight.

This aspect of the present invention also provides important advantages, since it enables the device to function both as a flashlight and as a generator for operating or recharging a mobile telephone or other battery-operated device.

According to a further preferred feature in this aspect of the invention, the light source and the electrical connector are carried at the same end of the housing, to enable the device to serve both functions at the same time, that is to illuminate the external electrical device to which it is to be connected.

According to a still further aspect of the present invention, there is provided a manually-operated device for supplying electrical power to an external electrical device, comprising an electrical generator enclosed within a housing dimensioned for hand-carrying by a user and including a drive member for manually driving the electrical generator to generate an electrical voltage at an output thereof; and a ring carried by the housing, the ring being openable and closable for attachment to a member supported on the body of the user, and/or for reception of keys to be carried by the user.

This aspect of the invention thus provides the further advantage of facilitating its being carried by the user so that it will be available whenever necessary, while also enabling it to be used as a conventional key ring for carrying keys by the user.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a three-dimensional front view illustrating one form of manually-operated device constructed in accordance with the present invention, and also schematically illustrating the main mechanical and electrical components in block-diagram form;

FIG. 2 is an end view of the device of FIG. 1;

FIG. 3 is a three-dimensional view illustrating the opposite side of the device of FIG. 1;

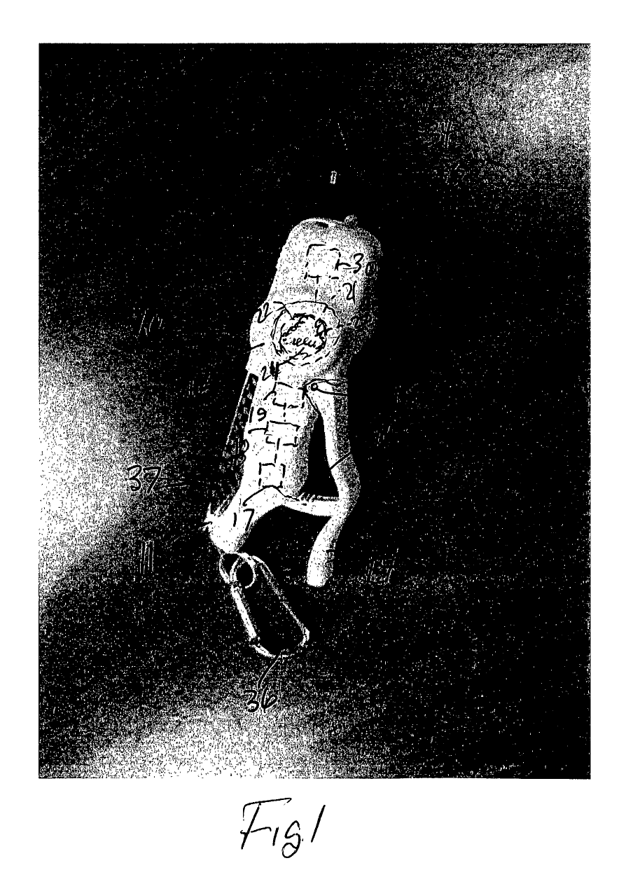

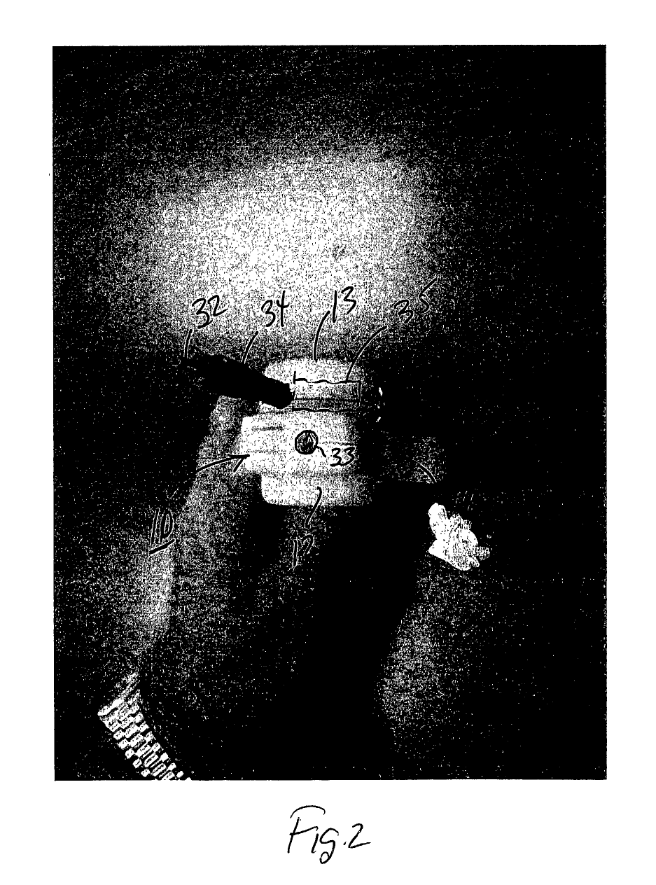

and FIG. 4 is a block diagram illustrating the main electrical components in the device of FIGS. 1-3.

### DESCRIPTION OF A PREFERRED EMBODIMENT

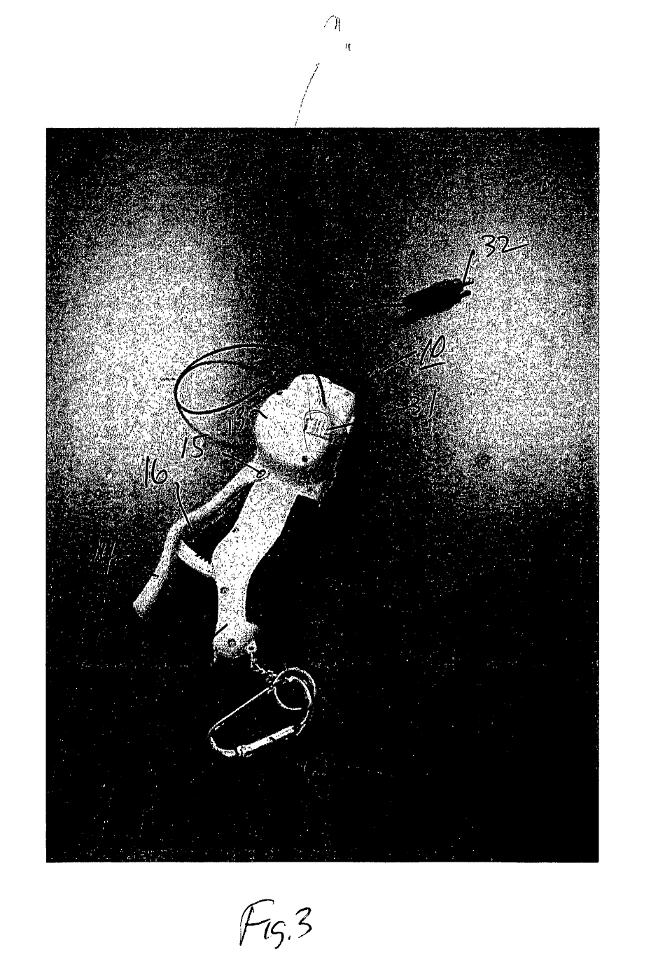

The manually-operated device illustrated in the drawings includes a housing, generally designated 10, dimensioned for hand-carrying by a user. Housing 10 includes an elongated main section 11 for hand-grasping by the user, a bulging cylindrical section 12 projecting from one side of the main section, and another bulging cylindrical section 13 (FIG. 2) projecting from the other side of the main section. As will be described more particularly below, cylindrical section 12 encloses an electrical generator for generating an electrical voltage. Cylindrical section 13 encloses a reeling device having a retractable extension cord carrying an electrical connector for connecting the generated electrical voltage to an external electrical device, such as a cellular telephone, flashlight, toy, or other battery-operated electrical device.

The illustrated manually-operated device further includes a manual drive member 14 pivotally mounted at 15 to the hand-grasping section 11 of the housing so as to be pivotal towards and away from that housing section in order to drive the electrical generator within housing section 12. A spring (not shown), e.g. a piano spring about pivotal mounting 15, urges drive member 14 to its outer position as illustrated in FIG. 1. Also, the device could be provided with a clip (not shown) for retaining manual drive member 14 in its inner position when the device is not in use.

Manual drive member 14 carries a curved rack 16 which is coupled by a transmission system within housing 10 to drive the electrical generator within housing section 12. Many types of transmission systems may be used for this purpose, such as those described in the above-cited U.S. Pat. No. 3,573,479 and U.K. Patent Application GB 2 347 800, the contents of which are incorporated herein by reference. A further transmission system that may be used for this purpose is one including a bi-directional rotary motion converter, such as described in U.S. Pat. No. 6,247,308 of Jun. 19, 2001, the contents of which are also incorporated herein by reference. Such a transmission system is schematically shown in FIG. 1 as including a gear mechanism 17 coupled to rack 16, a one-way clutch mechanism 18 converting the bi-directional pivotal movements of manual drive member 14 to a unidirectional rotary motion, and a flywheel 19 continuously rotated in one direction by the bi-directional pivotal movements of manual drive member 14.

It will thus be seen that the bi-directional pivotal movements of manual drive member 14 drive the rotor of the electrical generator enclosed within housing section 12.

FIG. 4 schematically illustrates the electrical generator within the box generally designated 20. Thus, as shown in FIG. 4, the electrical generator includes a rotary magnetic member 21 rotated unidirectionally by the bi-directional pivotal movements of manual drive member 14, and a plurality of coils 22, 23 and 24, fixedly mounted within housing section 12 so as to generate electrical voltages when the rotary magnetic member 21 is rotated.

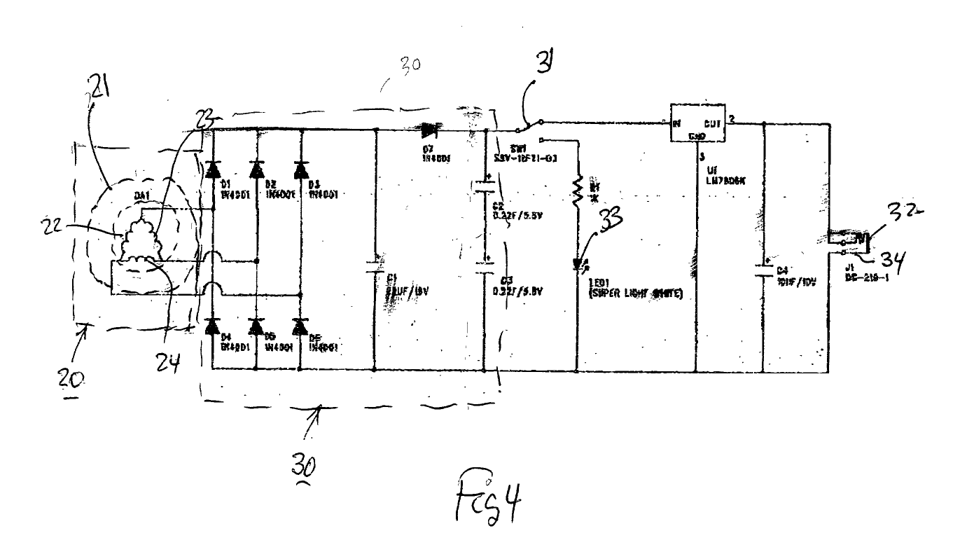

The voltages generated by coils 22-24 of magnetic generator 20 are rectified and controlled by a rectifier-control unit, schematically indicated by block 30 in FIG. 1, and more particularly illustrated in FIG. 4. Thus, as shown in FIG. 4, circuit 30 includes a plurality of rectifiers for rectifying and smoothing the outputs of the coils 22-24. The output of the rectifier and smoothing circuit is selectively fed, via a manual electrical switch 31 (FIGS. 3 and 4), to either an electrical terminal, schematically shown at 32 in FIG. 4, for connection to an external battery-operated device (such as a cellular telephone, flashlight, toy, etc.), or to a light source 33 carried by the illustrated manually-operated device to enable that device also to be used as a flashlight for illumination purposes.

As shown particularly in FIGS. 2 and 3, electrical terminal 32 supplied with the voltage generated by the electrical generator 20 is carried at one end of a retractable extension cord 34 wound on a reel, schematically shown at 35 in FIG. 2. FIGS. 1 and 2 illustrate the extension cord 34 in its fully retracted position, whereas FIG. 3 illustrates it in a partially-extended position. The inner end of extension cord 34 is connected, via manual switch 31, to the output of the electrical generator 20 so as to receive the voltage generated thereby in the retracted condition of the extension cord, as well as in any extended condition of that cord.

Light source 33, selectively powered by the electrical generator when driven by the manual drive member 14, may be any suitable light source, such as a small incandescent lamp, a light-emitting diode (LED), etc. As shown in FIGS. 1 and 2, it is located at the end of the main housing section 11 opposite to that grasped by the user and adjacent to the electrical connector 32 carried by the extension cord 34 wound on the reeling device 35 within housing section 13. Such an arrangement enables the illustrated device also to be used as a small flashlight, e.g. for finding in the dark a keyhole, the socket of the external electrical device to receive the connector 32, etc.

As shown in FIG. 1, the end of the main housing section 11 opposite to that carrying the electrical connector 32 and light source 33 is provided with a ring, generally designated 36. Ring 36 may be a conventional key ring which is openable and closable to enable the device to be conveniently carried by the user. For example, ring 36 may be of a construction enabling it to be supported on a belt or other member supported on the body of the user. It may also be used for receiving keys to be carried by the user.

As also seen in FIG. 1, the main housing section 11 also carries a reflector member 37, for ornamental purposes, and/or for use in reflecting light, e.g. to facilitate locating it in the dark.

Preferably, housing 10 is constructed of two half-sections of plastic material bonded together, e.g. by heat-welding, to enclose the transmission system (elements 17-19) coupling the manual drive member 14 to the rotary magnet 21 of the electrical generator 20 within housing section 12, the reel 35 (FIG. 2) carrying the extension cord 34 within housing section 13, and the rectifier-control circuit 30 (FIG. 1) within the main housing section 11.

### Use and Operation of Illustrated Device

The use and operation of the device illustrated in FIGS. 1-4 of the drawings will be apparent from the above description.

Thus, when the device is manually grasped by the user, the user may repeatedly apply a bi-directional pivotal movement to drive member 14, by squeezing that member towards the housing and then releasing it to permit spring return of that member. The bi-directional pivotal movements of member 14 are converted by the transmission system (elements 17-19) to a unidirectional rotary movement of magnet 21 within housing section 12, thereby generating, from the coils 22-24 fixed within that housing section, an electrical voltage at the output of the generator. This electrical voltage is rectified by rectifier-smoothing circuit 30 to a unidirectional voltage.

Manual switch 31 may direct the generated unidirectional voltage either to the electrical connector 32 carried at the end of the electrical extension cord wound on reel 35 within housing section 13, or to the light source 33 carried at the end of the housing. Thus, when the generated electrical voltage is applied to electrical connector 32, the illustrated device may be used for charging or powering another battery-operated device, such as a cellular telephone, flashlight, toy, or the like; and when electrical switch 31 directs the generated voltage to the light source 33, the device may be used as a small flashlight, e.g. for locating, in the dark, the socket of the battery-operated device to receive the electrical connector 32, as well as for other flashlight purposes.

The illustrated device thus enables a cellular telephone, flashlight, toy, or other battery-operated device to be electrically operated or to have its battery recharged while the battery-charger device is held and manipulated by one hand, and the other electrical device is held and manipulated by the other hand. In addition, the illustrated battery-charger device may be conveniently carried by the user via the ring 36, and may also be used as a key ring for holding the various keys of the user.

While the invention has been described with respect to one preferred embodiment, it will be appreciated that this is set forth merely for purposes of example, and that many other variations, modifications and applications of the invention may be made.

What is claimed is:

1. A manually-operated device for supplying electrical power to an external electrical device, comprising:
an electrical generator enclosed within a housing dimensioned for hand-carrying by a user and including a drive member for manually driving the electrical generator to generate an electrical voltage at an output thereof;
and a reeling device carried by said housing and having a retractable extension cord wound thereon, one end of said retractable extension cord being connected to the output of said electrical generator, the opposite end of said retractable extension cord carrying an electrical connector for connection to an external electrical device for supplying power thereto when said electrical generator is manually driven by said drive member.

2. The manually-operated device according to claim 1, wherein said housing is formed with an electrical generator section enclosing said electrical generator, and a reeling device section enclosing said reeling device and the retractable extension cord wound thereon.

3. The manually-operated device according to claim 2, wherein said housing is further formed with a hand-grasping section between said electrical generator section and said reeling device section.

4. The manually-operated device according to claim 3, wherein said drive member is pivotally mounted to said hand-grasping section of the housing so as to be pivotal towards and away from said hand-grasping section in order to drive said electrical generator.

5. The manually-operated device according to claim 4, wherein said pivotally-mounted drive member carries a rack which is driven inwardly and outwardly of said hand-grasping section of the housing by the hand of the user, said rack being coupled by a transmission system within said housing to said electrical generator for driving said electrical generator.

6. The manually-operated device according to claim 5, wherein said transmission system couples said pivotally-mounted drive member to said electrical generator by a gear mechanism including a one-way clutch and a flywheel rotated in one direction by the inward and outward movements of said drive member.

7. The manually-operated device according to claim 5, wherein said electrical generator includes a rotary magnetic member rotated by said pivotally-mounted drive member, and a stationary electrical coil generating a voltage upon the rotation of said rotary magnetic member.

8. The manually-operated device according to claim 1, wherein said housing further carries a light source and an electrical switch for selectively switching the output of said electrical generator to said extension cord for supplying power to said external electrical device when connected thereto, or to said light source for supplying power thereto to enable the device also to be used as a flashlight.

9. The manually-operated device according to claim 8, wherein said light source and said electrical connector are carried at the same end of said housing to enable the light source to illuminate the external electrical device to which the electrical connector is to be connected.

10. The manually-operated device according to claim 1, wherein said housing further carries a ring which is openable and closable for attachment to a member supported on the body of the user, and/or for reception of keys to be carried by the user.

11. The manually-operated device according to claim 1, wherein said housing further carries a reflector member for reflecting light therefrom.

12. A manually-operated device for supplying electrical power to an external electrical device, comprising:
an electrical generator enclosed within a housing dimensioned for hand-carrying by a user and including a drive member for manually driving the electrical generator to generate an electrical voltage at an output thereof;
an electrical connector connected to the output of said electrical generator for connection to an external electrical device;
a light source carried by said housing;
and an electrical switch for selectively switching the output of said electrical generator to said electrical connector for supplying power to the external electrical device when connected thereto, or to said light source for supplying power thereto to enable the device also to be used as a flashlight.

13. The manually-operated device according to claim 12, wherein said light source and said electrical connector are carried at the same end of said housing to enable the light source to illuminate the external electrical device to which the electrical connector is to be connected.

14. The manually-operated device according to claim 12, wherein said housing further carries a ring which is openable and closable for attachment to a member supported on the body of the user, and/or for reception of keys to be carried by the user.

15. The manually-operated device according to claim 12, wherein said housing further carries a reeling device having a retractable extension cord wound thereon, one end of said retractable extension cord being connected to the output of said electrical generator, the opposite end of said retractable extension cord carrying said electrical connector.

16. The manually-operated device according to claim 15, wherein said housing is formed with an electrical generator section enclosing said electrical generator, and a reeling device section enclosing said reeling device and the retractable extension cord wound thereon.

17. The manually-operated device according to claim 16, wherein said housing is further formed with a hand-grasping section between said electrical generator section and said reeling device section.

18. The manually-operated device according to claim 17, wherein said drive member is pivotally mounted to said hand-grasping section of the housing so as to be pivotal towards and away from said hand-grasping section in order to drive said electrical generator.

19. The manually-operated device according to claim 18, wherein said pivotally-mounted drive member carries a rack which is driven inwardly and outwardly of said hand-grasping section of the housing by the hand of the user, said rack being coupled by a transmission system within said housing to said electrical generator for driving said electrical generator.

20. The manually-operated device according to claim 19, wherein said transmission system couples said pivotally-mounted drive member to said electrical generator by a gear mechanism including a one-way clutch and a flywheel rotated in one direction by the inward and outward movements of said drive member.

21. The manually-operated device according to claim 19, wherein said electrical generator includes a rotary magnetic member rotated by said pivotally-mounted drive member, and a stationary electrical coil generating a voltage upon the rotation of said rotary magnetic member.

22. A manually-operated device for supplying electrical power to an external electrical device, comprising:
an electrical generator enclosed within a housing dimensioned for hand-carrying by a user and including a drive member for manually driving the electrical generator to generate an electrical voltage at an output thereof;
and a ring carried by said housing, said ring being openable and closable for attachment to a member supported on the body of the user, and/or for reception of keys to be carried by the user.

23. The manually-operated device according to claim 22, wherein said housing further carries a light source and an electrical switch for selectively switching the output of said electrical generator to said extension cord for supplying power to said external electrical device when connected thereto, or to said light source for supplying power thereto to enable the device also to be used as a flashlight.

24. The manually-operated device according to claim 23, wherein said light source and said electrical connector are carried at the same end of said housing to enable the light source to illuminate the external electrical device to which the electrical connector is to be connected.

25. The manually-operated device according to claim 24, wherein said housing further carries a reeling device having a retractable extension cord wound thereon, one end of said retractable extension cord being connected to the output of said electrical generator, the opposite end of said retractable extension cord carrying said electrical connector.

26. The manually-operated device according to claim 25, wherein said housing is formed with an electrical generator section enclosing said electrical generator, and a reeling device section enclosing said reeling device and the retractable extension cord wound thereon.

27. The manually-operated device according to claim 26, wherein said housing is further formed with a hand-grasping section between said electrical generator section and said reeling device section.

28. The manually-operated device according to claim 27, wherein said drive member is pivotally mounted to said hand-grasping section of the housing so as to be pivotal towards and away from said hand-grasping section in order to drive said electrical generator.

29. The manually-operated device according to claim 28, wherein said pivotally-mounted drive member carries a rack which is driven inwardly and outwardly of said hand-grasping section of the housing by the hand of the user, said rack being coupled by a transmission system within said housing to said electrical generator for driving said electrical generator.

30. The manually-operated device according to claim 29, wherein said transmission system couples said pivotally-mounted drive member to said electrical generator by a gear mechanism including a one-way clutch and a flywheel rotated in one direction by the inward and outward movements of said drive member.

31. The manually-operated device according to claim 29, wherein said electrical generator includes a rotary magnetic member rotated by said pivotally-mounted drive member, and a stationary electrical coil generating a voltage upon the rotation of said rotary magnetic member.
